(19) United States
(12) Patent Application Publication
(10) Pub. No.: US 2017/0192747 A1
(43) Pub. Date: Jul. 6, 2017

(54) INFORMATION PROCESSING APPARATUS AND DECIMAL NUMBER CONVERSION METHOD

(71) Applicant: FUJITSU LIMITED, Kawasaki-shi (JP)

(72) Inventor: Minoru Nakamura, Kawasaki (JP)

(73) Assignee: FUJITSU LIMITED, Kawasaki-shi (JP)

(21) Appl. No.: 15/372,469

(22) Filed: Dec. 8, 2016

(30) Foreign Application Priority Data
Jan. 4, 2016 (JP) 2016-000152

(51) Int. Cl. G06F 5/00

(52) U.S. Cl. CPC G06F 5/00

(57) ABSTRACT

A memory stores conversion data that indicates correspondence between each four-bit string in binary expression and a single digit in decimal expression. A processor selects four consecutive bits out of binary number data and, with reference to the conversion data, determines a value of one digit of decimal number data from a position of the selected four bits in the binary number data and a value of at least part of the selected four bits. The processor then subtracts a binary number corresponding to the determined value of the one digit from the binary number data, thus calculating a difference between them. The processor selects, out of the difference produced by the subtracting, another four consecutive bits located below the previously selected four bits and repeats the above determining to determine another decimal digit so as to convert the binary number data into decimal form.

### CROSS-REFERENCE TO RELATED APPLICATION

This application is based upon and claims the benefit of priority of the prior Japanese Patent Application No. 2016-000152, filed on Jan. 4, 2016, the entire contents of which are incorporated herein by reference.

### FIELD

The embodiments discussed herein relate to an information processing apparatus and a decimal number conversion method.

### BACKGROUND

The processor in a computer manipulates numerical values and stores them in a memory. Many of those values are expressed in the form of binary numbers, i.e., a series of bits each having a value of either 0 or 1. From the viewpoint of human users, it is preferable for computers to output numerical information in decimal form. A decimal number is composed of a number of digits, each taking one of the ten values 0, 1, 2, 3, 4, 5, 6, 7, 8, and 9. Computers therefore convert binary expression to decimal expression before outputting numerical values.

Suppose, for example, that a computer has a specific binary number for a database that stores numerical values in decimal form. The computer converts this binary number into a series of decimal digits each being expressed with at least four bits. For example, decimal digits may be expressed in the four-bit code called “binary-coded decimal” (BCD). To display some numbers on a monitor screen, the computer converts their source binary numbers into decimal form and further converts each decimal digit into a character code before outputting their images.

One binary-to-decimal conversion algorithm is to determine each decimal digit, from the least significant one to the most significant one, by repetitively dividing the source binary number by ten. More specifically, this simple algorithm first divides the binary number by ten (“1010” in binary) and places the remainder as the ones digit of a decimal number. The algorithm then uses the quotient as a new dividend, divides it by ten, and places the remainder as the tens digit of the decimal number. The algorithm uses the quotient as a new dividend, divides it by ten, and places the remainder as the hundreds digit. Such operations are repeated until the quotient becomes zero.

Other proposed techniques use a special circuit for binary-to-decimal conversion as part of a computer. For example, one binary-to-decimal conversion circuit includes a circuit that doubles the magnitude of a decimal numerical value. This conversion circuit first initializes a decimal data register to zero, thus making it ready to store a decimal number. The conversion circuit then shifts the binary number to the left by one bit while multiplying the decimal data register by two. This left-shift operation removes one bit out of the leftmost end of the binary number (i.e., the most significant bit). The conversion circuit adds the value of that removed bit to the decimal data register. The conversion circuit repeats these operations as many times as the number of bits of the binary number and outputs the resulting value in the decimal data register.

Yet another proposed binary-to-decimal conversion circuit includes a tenfold circuit that multiplies a decimal value by ten and a twofold circuit that multiplies a decimal value by two. The proposed conversion circuit is actually capable of eightfold multiplication by subtracting the twofold circuit's output from the tenfold circuit's. The conversion circuit first initializes a decimal data register to zero, thus making it ready to store a decimal number. The conversion circuit then shifts the binary number to the left by three bits while multiplying the decimal data register by eight. The left-shift operation removes the most significant three bits out of the binary number. The conversion circuit adds the value of these three bits to the decimal data register. The conversion circuit repeats the above operations until the least significant bit of the original binary number is removed and outputs the resulting value in the decimal data register.

Japanese Laid-open Patent Publication No. 11-65820

Japanese Laid-open Patent Publication No. 2000-200174

Many of the decimal numbers used by humans have zeros in their digits, particularly in lower successive digits, as in 5,000 and 67,000. The aforementioned simple conversion algorithm is, however, inefficient because it determines decimal digit_values one by one, from the lowermost digit to the uppermost digit. Other techniques described in the two documents noted above rely upon dedicated conversion circuits. These techniques necessitate a large amount of computation similarly to the simple algorithm, because they are unable to determine the value of any decimal digit before the given binary number is entirely scanned.

### SUMMARY

In one aspect of the embodiments discussed herein, there is provided an information processing apparatus including a memory and a processor. The memory is configured to store conversion data that indicates correspondence between each four-bit string in binary expression and a single digit in decimal expression. The processor is configured to perform a procedure including: selecting four consecutive bits out of binary number data; determining, with reference to the conversion data in the memory, a value of one digit of decimal number data from a position of the selected four bits in the binary number data and a value of at least part of the selected four bits; subtracting a binary number corresponding to the determined value of the one digit from the binary number data to calculate a difference therebetween; and selecting, out of the difference produced by the subtracting, another four consecutive bits located below the previously selected four bits and repeating the determining to determine another digit of the decimal number data so as to convert the binary number data into decimal form.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing apparatus according to a first embodiment;

FIG. 2 is a block diagram illustrating an exemplary hardware configuration of an information processing apparatus;

FIG. 3 is a block diagram illustrating an example of functions implemented in an information processing apparatus;

FIG. 4 illustrates an example of how decimal numbers are used;

FIG. 5 illustrates several exemplary relationships between a 4-bit portion of a binary number and one digit of a decimal number;

FIG. 6 illustrates an example of a conversion table;

FIG. 7 illustrates an example of an inverse conversion table;

FIG. 8 illustrates an example of binary-to-decimal conversion;

FIG. 9 illustrates an exemplary procedure of generating a conversion table;

FIG. 10 illustrates an exemplary procedure of binary-to-decimal conversion; and

FIG. 11 illustrates an example of a binary-to-decimal conversion program.

### DESCRIPTION OF EMBODIMENTS

Several embodiments will be described below with reference to the accompanying drawings.

### (a) First Embodiment

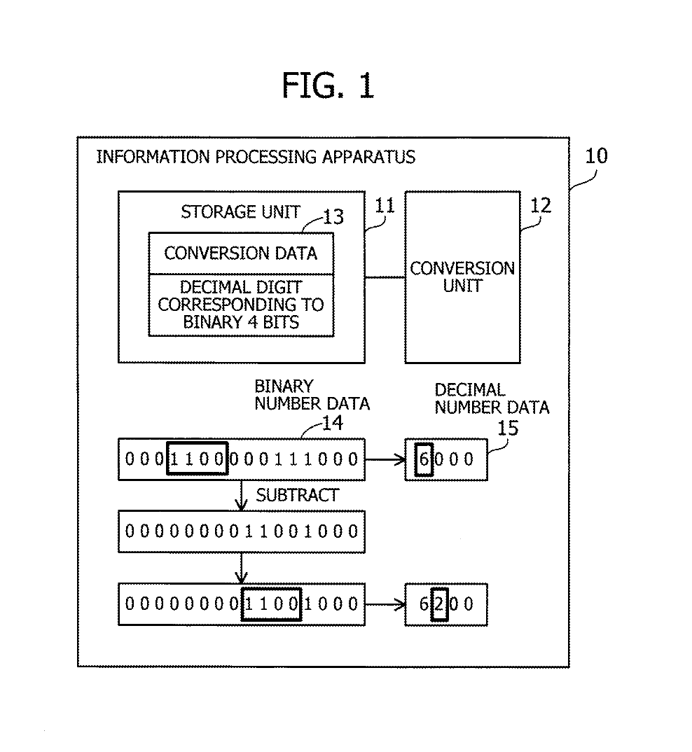

This part of the description explains a first embodiment. FIG. 1 illustrates an example of an information processing apparatus according to the first embodiment. The illustrated information processing apparatus 10 converts binary number data 14 into decimal number data 15. Binary number data 14 represents a numerical number in binary form and, more specifically, is a bit string formed from at least four bits each having a value of zero or one. The binary number system represents a series of integers with incremental bit strings as in 0, 1, 10, 11, 100, 101, 110, 111, 1000, 1001, 1010, 1011, 1100, 1101, 1110, 1111, and so on. Decimal number data 15 represents a numerical number in decimal form and, more specifically, has one or more digits each having one of the values of 0, 1, 2, 3, 4, 5, 6, 7, 8, and 9. For example, one decimal digit is expressed as a single data element formed from at least four bits. The decimal number data 15 may be a binary-coded decimal (BCD) number, each decimal digit being expressed as a four-bit binary number.

The information processing apparatus 10 may be, for example, a client computer or other client device. Alternatively, the information processing apparatus 10 may be a server computer or other similar device that is accessible to client devices.

The illustrated information processing apparatus 10 includes a storage unit 11 and a conversion unit 12. The storage unit 11 may be implemented as part of a volatile semiconductor memory, such as a random access memory (RAM), or of a non-volatile storage device, such as a hard disk drive (HDD) and flash memory. The conversion unit 12 may be implemented as, for example, a central processing unit (CPU), digital signal processor (DSP), or any other processing device. The conversion unit 12 may include an application-specific integrated circuit (ASIC), field-programmable gate array (FPGA), or any other electronic circuit for special purposes. Such a processor executes programs stored in a memory such as RAM. These programs include a decimal number conversion program that causes the processor to perform processing operations described below. The term “processor” may be used herein to refer to a single processing device or a multiprocessor system including two or more processing devices.

The storage unit 11 provides a storage space for conversion data 13. This conversion data 13 indicates correspondence between each four-bit string in binary expression and a single digit in decimal expression. The conversion data 13 may take the form of a table including a plurality of entries each associating a possible position and value of a four-bit binary string with a specific decimal digit and its value. The position of a four-bit string in a binary expression is expressed in terms of, for example, the distance of its foremost bit from the most significant bit or the least significant bit. It may be assumed that the foremost bit has a value of one. In that case, the conversion data 13 associates decimal digits and their values with various combinations of a possible position of such a foremost bit and a possible value of three consecutive bits subsequent to it.

Note that one specific combination of position and value of a four-bit binary string may correspond to two possible decimal digits or two possible decimal values. In other words, it is not always possible to uniquely determine a single decimal digit and its value from a given four-bit binary string. In view of this fact, each entry of the conversion data 13 may be configured to include a boundary value, a first digit, a first value, a second digit, and a second value in the decimal expression. When this is the case, either the first digit or the second digit is selected, together with one of the first and second values, according to comparison between the binary number data 14 and boundary value.

To convert binary number data 14 to decimal number data 15, the conversion unit 12 first selects four consecutive bits out of the binary number data 14. For example, the conversion unit 12 searches the binary number data 14, from the most significant bit to the least significant bit, for a bit having a predetermined value (e.g., 1). The conversion unit 12 selects a foremost bit that matches with this search condition and three bits that follow the foremost bit.

Upon selection of a four-bit string in the given binary number data 14, the conversion unit 12 determines a single-digit value of decimal number data 15 that corresponds to the selected four-bit string, with reference to the conversion data 13 in the storage unit 11. More specifically, the conversion unit 12 searches the conversion data 13 by using the position of the selected four-bit string (e.g., position of its foremost bit) in the binary number data 14 and the value of at least some of the selected four bits (e.g., three bits that follow the foremost bit) as search keys. The conversion unit 12 retrieves a single decimal digit and its value by searching the conversion data 13 and determines a single-digit value for the decimal number data 15 on the basis of the retrieved data.

The conversion unit 12 then subtracts a binary number corresponding to the determined single-digit value from the binary number data 14. Suppose, for example, the conversion unit 12 has determined that the decimal number data 15 has a value of six in the thousands digit. In this exemplary case, the conversion unit 12 subtracts a binary number equivalent to decimal 6,000 from the binary number data 14. The conversion unit 12 repeats the above processing for the remainder in the binary number data 14. That is, the conversion unit 12 selects another four-bit string out of the binary number data 14 after the subtraction. This newly selected four-bit string is less significant than the previously selected four-bit string. The conversion unit 12 determines another single-digit value in the decimal number data 15 that corresponds to the newly selected four-bit string.

The conversion unit 12 repeats the above-described process until the binary number data 14 becomes zero, thereby converting the binary number data 14 into decimal number data 15. As a variation, the conversion unit 12 may be configured to repeat the same until the binary number data 14 falls below ten and then directly determine the least significant digit of decimal number data 15 without referring to the conversion data 13. Although not mentioned above, every digit of decimal number data 15 is initialized to zero at the start of the conversion process.

In operation of the first embodiment, the proposed information processing apparatus 10 performs a method described below. The method selects four consecutive bits out of given binary number data 14 and determines a single-digit value in decimal number data 15 from the position of the selected four bit string and the value of at least a part of the same string. The method then executes a subtraction of a binary number corresponding to the determined single-digit number from the binary number data 14. The method repeats the above operations on the remainder in the binary number data 14, thereby converting the binary number data 14 into decimal number data 15.

The proposed method reduces the amount of computation for converting binary number data 14 into decimal number data 15. Particularly, the method works more effectively than the conventional simple algorithm that determines decimal digits one by one, from the least significant digit to the most significant digit, by repetitively dividing the source binary number by ten (1010 in binary). For example, the proposed method searches the binary number data 14 for a bit having a predetermined value (e.g., 1) and selects that bit and three subsequent bits, while skipping bit strings having other values (e.g., 0000 . . . ). In other words, the proposed method has only to repeat the noted processing as many times as the number of non-zero digits in the given decimal number data 15; there is no need for executing the above processing to determine zero-valued digits. The proposed method is therefore capable of converting numbers efficiently when their decimal expressions have many zero-valued digits.

The conversion data 13 has a searchable data structure for the purpose of determining a single decimal digit. Preferably, the conversion data 13 may be configured to return a decimal digit corresponding to a string of four binary bits. The conversion unit 12 may preferably be configured to exactly select four bits each time a bit string is taken out of binary number data 14. It is possible, however, to modify the conversion data 13 to enable a search for a decimal digit corresponding to five or more binary bits. The conversion unit 12 is then modified to select five or more bits each time a bit string is taken out of binary number data 14. In other words, the conversion data 13 has a searchable structure that returns one decimal digit (or candidates therefor) corresponding to at least four bits in binary expression. The conversion unit 12 is configured to select at least four bits each time it extracts a portion of a source binary number given in the binary number data 14.

### (b) Second Embodiment

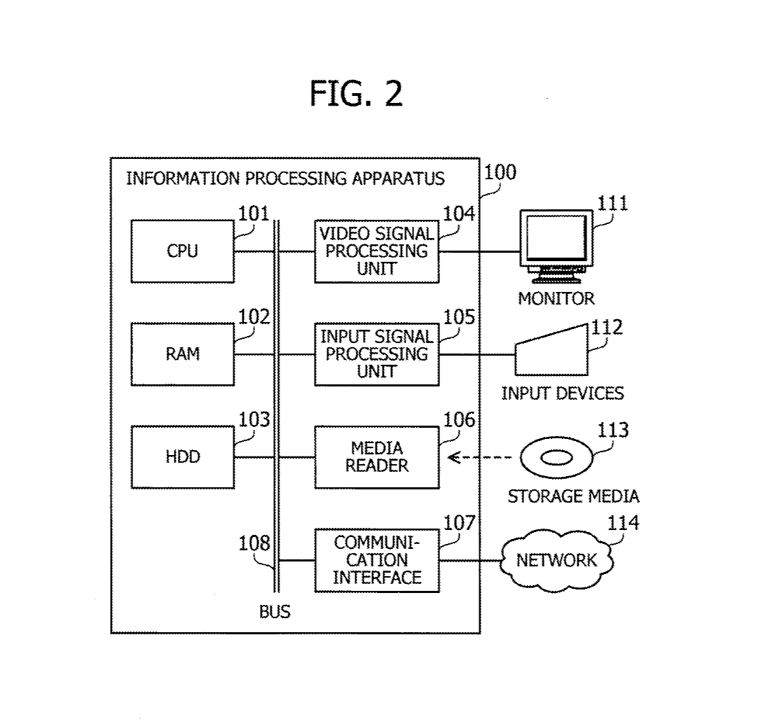

This part of the description describes a second embodiment. FIG. 2 is a block diagram illustrating an exemplary hardware configuration of an information processing apparatus. The illustrated information processing apparatus 100 of the second embodiment includes a CPU 101, a RAM 102, an HDD 103, a video signal processing unit 104, an input signal processing unit 105, a media reader 106, and a communication interface 107, all of which are connected to a bus 108. This information processing apparatus 100 of the second embodiment is equivalent to the information processing apparatus 10 discussed in the first embodiment. Specifically, the CPU 101 corresponds to the foregoing conversion unit 12, and the RAM 102 or HDD 103 corresponds to the foregoing storage unit 11.

The CPU 101 is a processor containing computational circuits to execute programmed instructions.

The CPU 101 reads out at least part of program and data files stored in the HDD 103 and executes programs after loading them on the RAM 102. The CPU 101 may include a plurality of processor cores, and the information processing apparatus 100 may include two or more such processors. These processors or processor cores may be used to execute processing operations (described later) in a parallel fashion. The term “processor” is used to refer to a single processing device or a multiprocessor system including two or more processing devices.

The RAM 102 is a volatile semiconductor memory device that temporarily stores programs that the CPU 101 executes, as well as various data objects that the CPU 101 manipulates in the course of computation. Other type of memory devices may be used in place of or together with the RAM 102, and the information processing apparatus 100 may have two or more sets of such memory devices.

The HDD 103 serves as a non-volatile storage device to store program and data files of the operating system (OS), middleware, applications, and other kinds of software. The decimal number conversion program discussed herein is one of those programs stored in the HDD 103. The information processing apparatus 100 may include a plurality of non-volatile storage devices such as flash memories and solid state drives (SSD) in place of or together with the HDD 103.

The video signal processing unit 104 produces video images in accordance with commands from the CPU 101 and outputs them on a screen of a monitor 111 coupled to the information processing apparatus 100. The monitor 111 may be, for example, a cathode ray tube (CRT) display, liquid crystal display (LCD), plasma display panel (PDP), organic electro-luminescence (OEL) display, or any other display device.

The input signal processing unit 105 receives input signals from input devices 112 and supplies them to the CPU 101. The input devices 112 include pointing devices (e.g., mouse, touchscreen, touchpad, trackball), keyboards, remote controllers, push button switches, and the like. The information processing apparatus 100 allows connection of two or more input devices of different categories.

The media reader 106 is a device used to read programs and data stored in storage media 113. The storage media 113 include, for example, magnetic disk media such as flexible disk (FD) and HDD, optical disc media such as a compact disc (CD) and digital versatile disc (DVD), magneto-optical discs (MO), and semiconductor memory devices. The media reader 106 transfers programs and data read out of a storage medium 113 to, for example, the RAM 102 or HDD 103.

The communication interface 107 is connected to a network 114 to permit the CPU 101 to communicate with other devices over the network 114. The communication interface 107 may be a wired network interface or a wireless network interface. In the former case, the information processing apparatus 100 is connected to a network device (e.g., switch) via a cable. In the latter case, the information processing apparatus 100 is linked to a base station or an access point via a radio link.

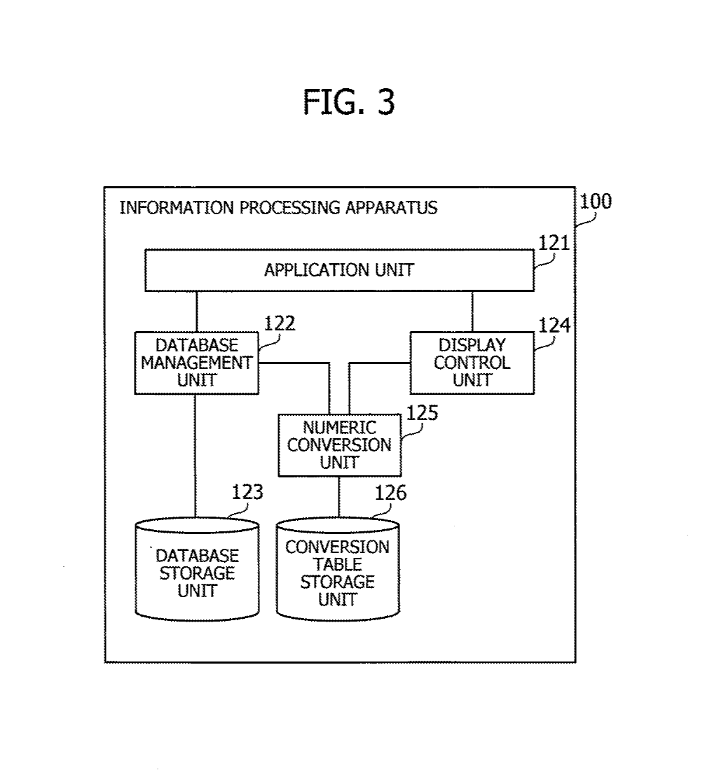

FIG. 3 is a block diagram illustrating an example of functions implemented in an information processing apparatus. The illustrated information processing apparatus 100 includes an application unit 121, a database management unit 122, a database storage unit 123, a display control unit 124, a numeric conversion unit 125, and a conversion table storage unit 126. For example, the application unit 121, database management unit 122, display control unit 124, and numeric conversion unit 125 may be implemented in the form of program modules that the CPU 101 executes. The database storage unit 123 and conversion table storage unit 126 may be implemented as storage spaces reserved in the RAM 102 or HDD 103 or both.

The application unit 121 executes application software that handles numerical values. These numerical values are usually represented in binary form. There are many numerical data types, including 8-bit signed integer, 8-bit unsigned integer, 16-bit signed integer, 16-bit unsigned integer, 32-bit signed integer, 32-bit unsigned integer, 64-bit signed integer, 64-bit unsigned integer, and the like. The application unit 121 may interact with the database management unit 122 to enter numerical values to databases. The application unit 121 may also interact with the display control unit 124 to display numerical values on a screen of the monitor 111.

The database management unit 122 manages databases stored in the database storage unit 123. For example, the database management unit 122 adds new data to a database, changes or deletes existing data in a database, and searches such databases for specific pieces of data. Some databases may contain numerical data in decimal form. To enter decimal data to a database, the database management unit 122 requests the numeric conversion unit 125 to convert binary numbers into decimal numbers.

The database storage unit 123 stores databases in which each set of data is organized in accordance with a defined data structure. As mentioned above, databases may contain numerical data in decimal form. Decimal numerical data represents numbers in the form of a collection of decimal digits each represented by a string of four or more bits. For example, the digits of a decimal number may take the form of four-bit BCD.

The display control unit 124 displays images on a screen of the monitor 111 according to requests from the application unit 121. These displayed images may include numeric characters. In that case, the display control unit 124 requests the numeric conversion unit 125 to convert binary numbers to decimal numbers. The decimal numbers that the display control unit 124 receives are organized as a collection of bit strings, four bits per digit, similar to those handled by the database management unit 122. The display control unit 124 converts the values of respective decimal digits into their corresponding character codes and outputs character images indicated by these codes. Here the display control unit 124 may use any appropriate character encoding system, such as the American Standard Code for Information Interchange (ASCII), Unicode Transformation Format in 8 bits (UTF-8), and UTF in 32 bits (UTF-32). Although the present description assumes displaying numerical character strings on the monitor 111, the second embodiment may be modified to output result data in the form of a computer file.

The numeric conversion unit 125 converts binary numbers into decimal numbers upon request from the database management unit 122 or display control unit 124. The details of this conversion will be described later. The following example assumes that binary numbers are represented in the form of 64-bit unsigned integers. A 64-bit unsigned integer represents an integer in the range of 0 to 18,446,744,073,709,551,615. Negative binary numbers may be converted into decimal form by reversing their sign, converting the resulting positive binary numbers into positive decimal numbers in the way described later, and adding a negative sign to the result. In the case where a negative binary number is represented in two's complement, its sign can be reversed by first negating bitwise values and then adding one to the result. The following example also assumes that each digit of a decimal number is represented in an 8-bit unsigned integer.

The conversion table storage unit 126 is where to record control data the numeric conversion unit 125 uses. As will be described later, the conversion table storage unit 126 actually stores a conversion table for determining one decimal digit corresponding to four binary bits. The conversion table storage unit 126 also stores an inverse conversion table for calculating a binary number back from a single decimal digit. The conversion table and inverse conversion table are created beforehand (e.g., by the user of the information processing apparatus 100 or the programmer of a module corresponding to the numeric conversion unit 125) and stored in the conversion table storage unit 126. Alternatively, the numeric conversion unit 125 may produce these tables when a need arises. The description offers in later sections the details of the conversion table and inverse conversion table, as well as a detailed method for creating a conversion table.

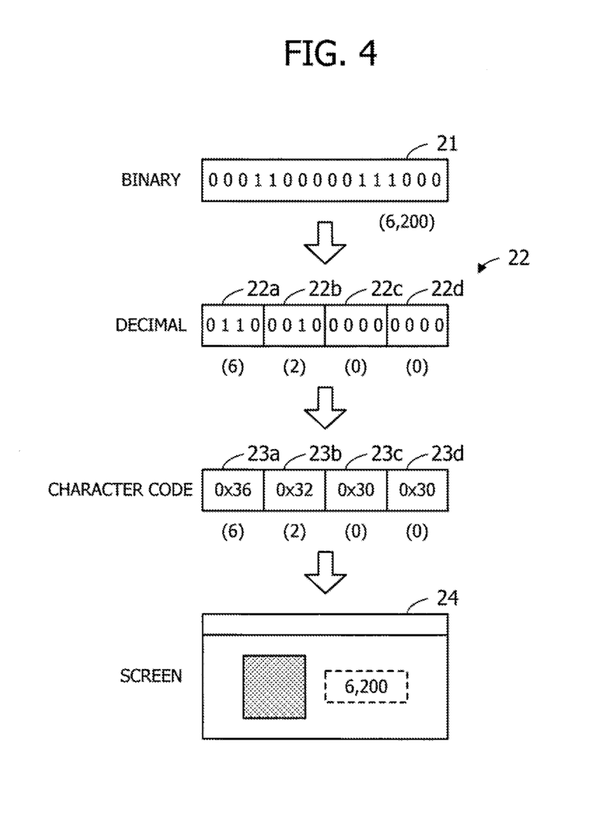

FIG. 4 illustrates an example of how decimal numbers are used. The illustrated binary number 21 has a value of 0001100000111000, which is equivalent to 6,200 in decimal. For example, this binary number 21 was produced by the application unit 121 in response to a user input and resides in the RAM 102. The numeric conversion unit 125 now converts the binary number 21 to a decimal number 22. For simplicity purposes, FIG. 4 only illustrates the lowest 16 bits of the binary number 21 and the lowest four digits of the decimal number 22.

Specifically, the decimal number 22 is composed of four digits 22a, 22b, 22c, and 22d, respectively representing the thousands place, hundreds place, tens place, and ones place. For simplicity purposes, FIG. 4 only illustrates the lowest four bits of each digit 22a, 22b, 22c, and 22d. The decimal number 22 has a value of 6,200. That is, the thousands digit 22a has a value of 6 (0110 in binary). The hundreds digit 22b has a value of 2 (0010 in binary). The tens digit 22c has a value of 0 (0000 in binary). The ones digit 22d has a value of 0 (0000 in binary).

To handle the number “6200” as a character string, the numerical values of its digits 22a, 22b, 22c, and 22d are respectively converted into character codes 23a, 23b, 23c, and 23d. The first character code 23a corresponds to the thousands digit 22a and has a value of 0x36 to represent a character “6.” The second character code 23b corresponds to the hundreds digit 22b and has a value of 0x32 to represent a character “2.” The third character code 23c corresponds to the tens digit 22c and has a value of 0x30 to represent a character “0.” The fourth character code 23d corresponds to the ones digit 22d and has a value of 0x30 to represent a character “0.” Here, the ASCII code is used as the character encoding system.

Now that a series of character codes 23a, 23b, 23c, and 23d has been produced from the decimal number 22, the display control unit 124 draws an image of a character string “6200” on a screen 24. This screen 24 appears on the monitor 111. The character string may also be entered in a computer file. When this is the case, the character codes 23a, 23b, 23c, and 23d are written into a file in that order.

The description will now explain an algorithm for converting binary numbers to decimal numbers. As mentioned previously, there is a simple conversion algorithm that repetitively divides a given binary number by ten (1010 in binary), so that decimal digits are determined from the lowest one in a stepwise manner. More specifically, the ones digit is obtained as the remainder of a division of the binary number by ten, and then the tens digit is obtained as the remainder of a division of the previous quotient by ten. This operation is repeated until the quotient becomes zero, thereby determining all decimal digits.

The noted simple conversion algorithm includes as many divisions as the number of decimal digits. However, the numbers used by humans tend to include zeros in their digits, and the numbers representing monetary values often include a series of zeros in their lower digits. In view of this fact, the second embodiment is designed to determine decimal digit values in the direction from the most significant digit to the least significant digit, unlike the noted simple conversion algorithm. The second embodiment is also designed to skip zero-valued digits, rather than repeating the same computation at every digit of a decimal number.

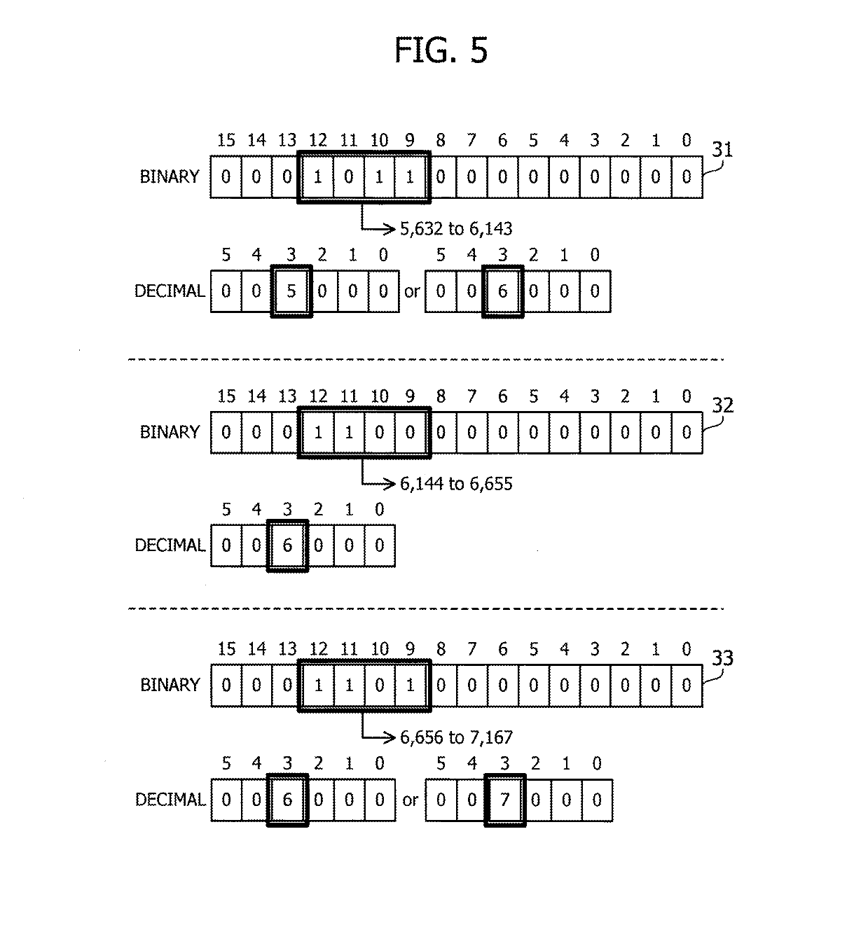

FIG. 5 illustrates several exemplary relationships between a 4-bit portion of a binary number and one digit of a decimal number. The following description may use the symbol “bit[0]” to refer to the least significant bit (LSB) of a binary number. Likewise, other bits may be expressed as “bit[1],” “bit[2],” and so on, in the order toward the most significant bit (MSB) of the binary number. It is assumed that binary numbers are 64 bits in length, whose MSB is bit[63]. The following description may also use the symbol “digit[0]” to refer to the least significant digit of a decimal number, as well as digit[1], digit[2], and so on to represent other digits toward the most significant digit. It is assumed that decimal numbers are 20 digits in length, whose most significant digit is digit[19]. FIG. 5, however, illustrates only the lowest sixteen bits of binary numbers and the lowest six digits of decimal numbers.

The binary number 31 seen in the topmost place of FIG. 5 has a value of 0001011000000000. The numeric conversion unit 125 searches the bit string of this binary number 31, from MSB to LSB, for a bit with a value of one. The numeric conversion unit 125 now sees a bit “1” encountered in the first place. The bit detected in this way may be referred to as the “most significant set bit.” The numeric conversion unit 125 selects the most significant set bit and three bits subsequent thereto. In the present example of FIG. 5, the numeric conversion unit 125 selects bit[12], bit[11], bit[10], and bit[9] of the binary number 31.

The selected four bits have a value of 1011. The position and value of the selected four bits suggest that the binary number 31 is within a limited range of 5,632 to 6,143. The lower bound of this range corresponds to the case in which every lower bit below the four bits has a value of zero. The upper bound of the range corresponds to the case in which every lower bit below the four bits has a value of one. Accordingly the numeric conversion unit 125 determines that decimal digit[3] is either 5 or 6. That is, digit[3] is 5 when the binary number 31 is 5,999 or below. Digit[3] is 6 when the binary number 31 is 6,000 or above.

The next exemplary binary number 32 in FIG. 5 has a value of 0001100000000000. The numeric conversion unit 125 selects the most significant set bit (bit[12]) and subsequent three bits (bit[11], bit[10], and bit[9]) of this binary number 32 in the same way as discussed above for the binary number 31. The selected four bits have a value of 1100. The position and value of the selected four bits suggest that the binary number 32 is within a limited range of 6,144 to 6,655. Accordingly the numeric conversion unit 125 determines that decimal digit[3] has to be 6.

The next exemplary binary number 33 seen in the bottommost part of FIG. 5 has a value of 0001101000000000. The numeric conversion unit 125 selects the most significant set bit (bit[12]) and subsequent three bits (bit[11], bit[10], and bit[9]) of this binary number 33 in the same way as discussed above for the binary numbers 31 and 32. The selected four bits have a value of 1101. The position and value of the selected four bits suggest that the binary number 33 is within a limited range of 6,656 to 7,167. Accordingly the numeric conversion unit 125 determines that decimal digit[3] is either 6 or 7. That is, digit[3] is 6 when the binary number 33 is 6,999 or below. Digit[3] is 7 when the binary number 33 is 7,000 or above.

As can be seen from the above examples, the numeric conversion unit 125 narrows down the possible decimal digit positions and possible values to at most two patterns (i.e., one or two candidate patterns), based on the position and value of consecutive four bits selected out of a binary number. In the case of two candidates, the numeric conversion unit 125 compares the binary value with a relevant boundary value and selects one of them according to the comparison result. For example, the boundary value is 5,999 for the topmost binary number 31 in FIG. 5. It is 6,999 for the bottommost binary number 33 in FIG. 5.

Although four bits are selected in the above examples, the numeric conversion unit 125 may be configured to select a fewer bits at a time. In the case of, say, three bits, the numeric conversion unit 125 may find three or more candidate patterns for its decimal digit position and value. Such an increase in the number of candidates would complicate the process of selecting a single candidate since the binary number has to be compared with multiple boundary values. The numeric conversion unit 125 may, on the other hand, select five or more bits at time, but this alternative has no advantage in terms of the number of candidate patterns (i.e., there would still be two candidates) because the n-th power of 2 can never be a multiple of 10, where n is an integer greater than one. It is therefore preferable for the numeric conversion unit 125 to select four bits at a time.

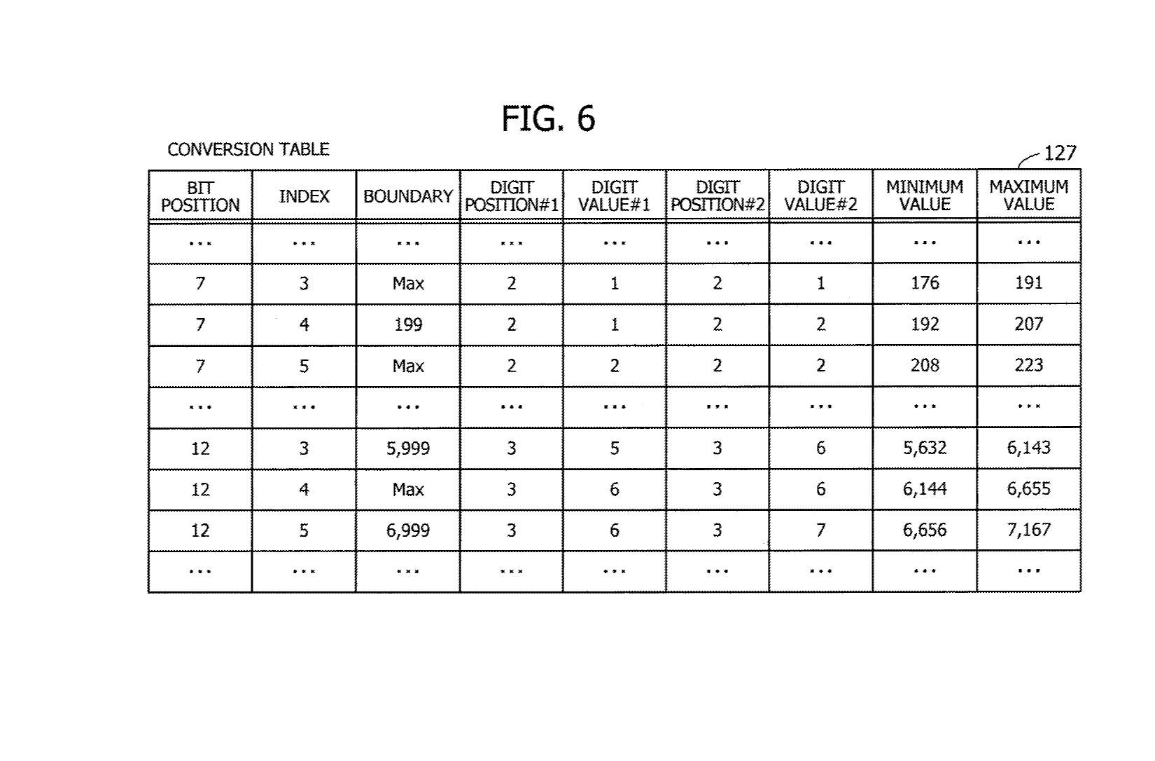

FIG. 6 illustrates an example of a conversion table. This conversion table 127 is stored in the conversion table storage unit 126 (FIG. 3). Specifically, the illustrated conversion table 127 is formed from the following data fields: Bit Position, Index, Boundary, Digit Position #1, Digit Value #1, Digit Position #2, Digit Value #2, Minimum Value, and Maximum Value.

The bit position field contains an integer that indicates a possible position of the most significant set bit (i.e., the uppermost bit with a value of one) in a binary number, where bit position 0 refers to the LSB and bit position 63 refers to the MSB of the binary number. The smallest value of bit positions is three in this conversion table 127 since the numeric conversion unit 125 is designed to select four bits at a time from a binary number. The index field contains each possible value that the three bits subsequent to the most significant set bit may have. The index values range from 0 to 7.

The boundary field gives a threshold for use in determining which of digit position #1 and digit position #2 is valid, as well as which of digit value #1 and digit value #2 is valid. That is, the numeric conversion unit 125 compares the binary number as a whole with a relevant boundary value and takes the digit position #1 and digit value #1 fields as being valid if the binary number is equal to or smaller than the boundary value. The numeric conversion unit 125 takes the digit position #2 and digit value #2 fields as being valid if the binary number is greater than the boundary value. When the combination of bit position and index falls into a single pattern of a binary digit and value, the conversion table 127 indicates this fact by giving a predetermined maximum value in the boundary field. For example, the boundary field may contain a value of 18,446,744,073,709,551,615, which is the largest number that a 64-bit unsigned integer can represent. This number is indicated by the symbol “Max” in FIG. 6 and forces the numeric conversion unit 125 to select the digit position #1 field and digit value #1 field.

The digit position #1 and #2 fields contain integers each indicating a specific digit position in a decimal number. For example, the digit position #1 and #2 fields may contain a value of 0 to indicate the least significant digit. They may contain a value of 19 to indicate the most significant digit. The digit value #1 and #2 fields contain integers each indicating a specific value of a single digit of the decimal number. The smallest value in the digit value #1 and #2 fields is not zero, but one, because the numeric conversion unit 125 is supposed to select four bits starting with a value of one. The largest value in the digit value #1 and #2 fields is nine. When the combination of bit position and index falls into a single pattern of a binary digit and value, the digit position #1 and #2 fields contain the same value, as do the digit value #1 and #2 fields. Otherwise, the digit position #1 field gives a smaller value than the digit position #2 field, and the digit value #1 field gives a smaller value than the digit value #2 field.

The minimum value field contains the smallest possible integer that a binary number may represent when it satisfies the conditions seen in the bit position field and index field. More specifically, this minimum value is given under the assumption that all binary bits subsequent to the selected four bits are zeros. The minimum value field corresponds to the digit position #1 and digit value #1 fields. The maximum value field contains the largest possible integer that a binary number may represent when it satisfies the conditions seen in the bit position field and index field. More specifically, this maximum value is given under the assumption that all binary bits subsequent to the selected four bits are ones. The maximum value field corresponds to the digit position #2 and digit value #2 fields. Note the conversion table 127 may omit the minimum value and maximum value fields because they are only for reference purposes.

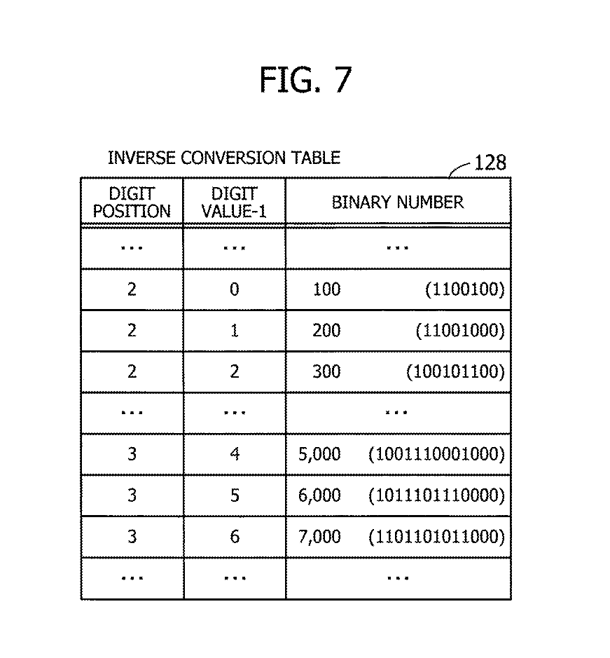

FIG. 7 illustrates an example of an inverse conversion table. This inverse conversion table 128 is stored in the conversion table storage unit 126 (FIG. 3). Specifically, the illustrated inverse conversion table 128 is formed from the following data fields: Digit Position, Digit Value-1, and Binary Number.

The digit position field contains an integer that represents a specific digit position in a decimal number. For example, the digit position field may contain a value of 0 to indicate the least significant digit, similarly to its counterpart in the foregoing conversion table 127. The value of 19 in this field indicates the most significant digit. The digit value-1 field contains an integer that represents a single digit value of a decimal number minus one, which ranges from zero to eight. The binary number field contains a binary number equivalent to a decimal number produced by placing a digit value (i.e., value in the digit value-1 field plus one) at the digit designated by the digit position field and filling all other digits with zeros. The binary number field in FIG. 7 gives both of such decimal numbers and binary numbers, the latter in parentheses.

Take the table entry containing digit position=2 and digit value-1=1, for example. The inverse conversion table 128 gives a decimal number of 200 in this entry, whose corresponding binary number is 11001000. Take another entry containing digit position=3 and digit value-1=5. The inverse conversion table 128 gives a decimal number of 6,000 in this entry, whose corresponding binary number is 1011101110000.

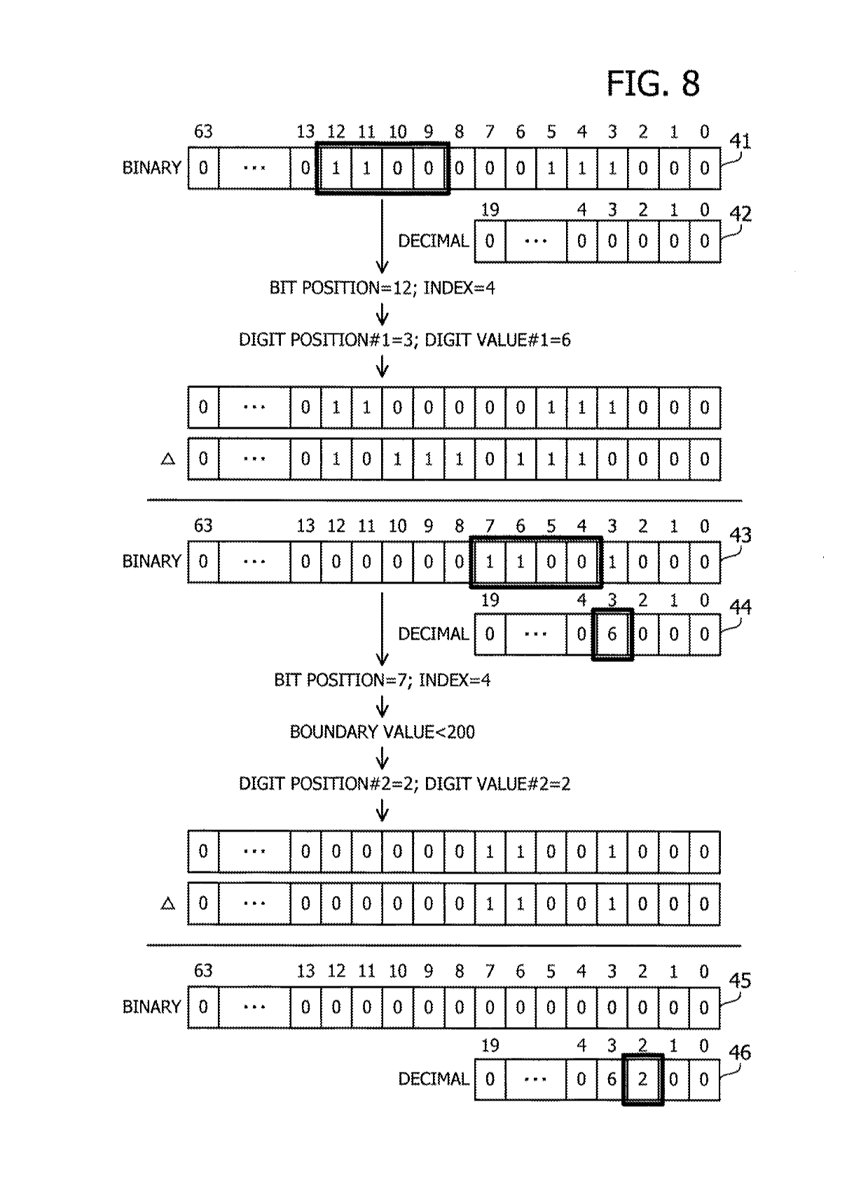

FIG. 8 illustrates an example of binary-to-decimal conversion. Here the numeric conversion unit 125 converts a given binary number to a decimal number in the following way, using the above-described conversion table 127 and inverse conversion table 128.

Specifically, the source binary number 41 seen in the topmost part of FIG. 8 has a value of 0 . . . 01100000111000, which is equivalent to 0 . . . 06,200 in decimal form. The numeric conversion unit 125 first produces an initial version of a decimal number 42 by clearing every digit to zero. The numeric conversion unit 125 then scans the binary number 41 from bit[63] toward bit[0], thus detecting its most significant set bit. In the present example, the most significant set bit is found at bit[12]. The numeric conversion unit 125 selects this most significant set bit and subsequent three bits (i.e., bit[12] to bit[9] as indicated by a bold box in FIG. 8).

The numeric conversion unit 125 thus obtains a bit position of 12, as well as an index of 4 from bit[11]=1, bit[10]=0, and bit[9]=0. Then, with reference to the conversion table 127, the numeric conversion unit 125 seeks a boundary value corresponding to the combination of bit position=12 and index=4. The conversion table 127 returns a predetermined maximum value (Max) as the boundary value. The numeric conversion unit 125 compares the binary number 41 with this boundary value, thus determining that the binary number 41 is not greater than the boundary value Max. Accordingly, the numeric conversion unit 125 retrieves values from the corresponding digit position #1 and digit value #1 fields of the conversion table 127. As seen in FIG. 6, the digit position #1 field contains a value of 3, and the digit value #1 field contains a value of 6.

The numeric conversion unit 125 now produces a new decimal number 44 by changing digit[3] of the initial decimal number 42 from 0 to 6. The numeric conversion unit 125 then turns to the inverse conversion table 128 and retrieves therefrom a binary number that corresponds to the combination of digit position=3 and digit value-1=5. The retrieved binary number is 0 . . . 01011101110000, which is equivalent to a decimal number of 6,000. The numeric conversion unit 125 produces another binary number 43 by subtracting the retrieved binary number from the source binary number 41.

The resulting binary number 43 has a value of 0 . . . 00000011001000, which is equivalent to a decimal number of 0 . . . 00200. The numeric conversion unit 125 now scans the binary number 43 from bit[63] toward bit[0], thus detecting its most significant set bit. In the present example, the most significant set bit is found at bit[7]. The numeric conversion unit 125 selects this most significant set bit and subsequent three bits (i.e., bit[7] to bit[4]).

The numeric conversion unit 125 thus obtains a bit position of 7, as well as an index of 4 from bit[6]=1, bit[5]=0, and bit[4]=0. Then, with reference to the conversion table 127, the numeric conversion unit 125 seeks a boundary value corresponding to the combination of bit position=7 and index=4. The conversion table 127 returns a boundary value of 199. The numeric conversion unit 125 compares the binary number 43 with this boundary value, 199, thus determining that the binary number 43 is greater than the boundary value. Accordingly, the numeric conversion unit 125 retrieves values from the corresponding digit position #2 and digit value #2 fields of the conversion table 127. Here both the digit position #2 field and digit value #2 field contain a value of 2.

The numeric conversion unit 125 now obtains yet another decimal number 46 by changing digit[2] of the decimal number 44 from 0 to 2. The numeric conversion unit 125 then turns to the inverse conversion table 128 and retrieves therefrom a binary number that corresponds to the combination of digit position=2 and digit value-1=1. The retrieved binary number has a value of 0 . . . 00000011001000, which is equivalent to a decimal number of 200. The numeric conversion unit 125 produces yet another binary number 45 by subtracting the retrieved binary number from the current binary number 43.

The resulting binary number 45 has a value of 0 . . . 00000000000000, which is equivalent to a decimal number of . . . 00000. Since there is no remainder to process, the numeric conversion unit 125 concludes the binary-to-decimal conversion process. The given source binary number 41 has been converted into a decimal number 46 equivalent thereto. The value of this decimal number 46 is 0 . . . 06200.

The above-described conversion process has made two references to the conversion table 127 and two references to the inverse conversion table 128, besides two binary subtractions. Here the number “two” derives from the number of non-zero digits in the decimal number 46. In other words, the above-described conversion process skipped zero-valued digits. This is because of the fact that the numeric conversion unit 125 skips leading zeros in binary numbers 41 and 43 during the course of seeking their most significant set bits.

Some binary numbers, when converted into decimal numbers, have many zero-valued digits, while others do not. The proposed conversion method reduces the amount of computation in binary-to-decimal conversion particularly in the case of the former group of binary numbers. For example, the numbers describing the amount of money often have many zeros in their lower digits. The proposed method is particularly advantageous in converting such binary numbers into decimal form.

The next part of the description will now explain specific procedures that the information processing apparatus 100 performs.

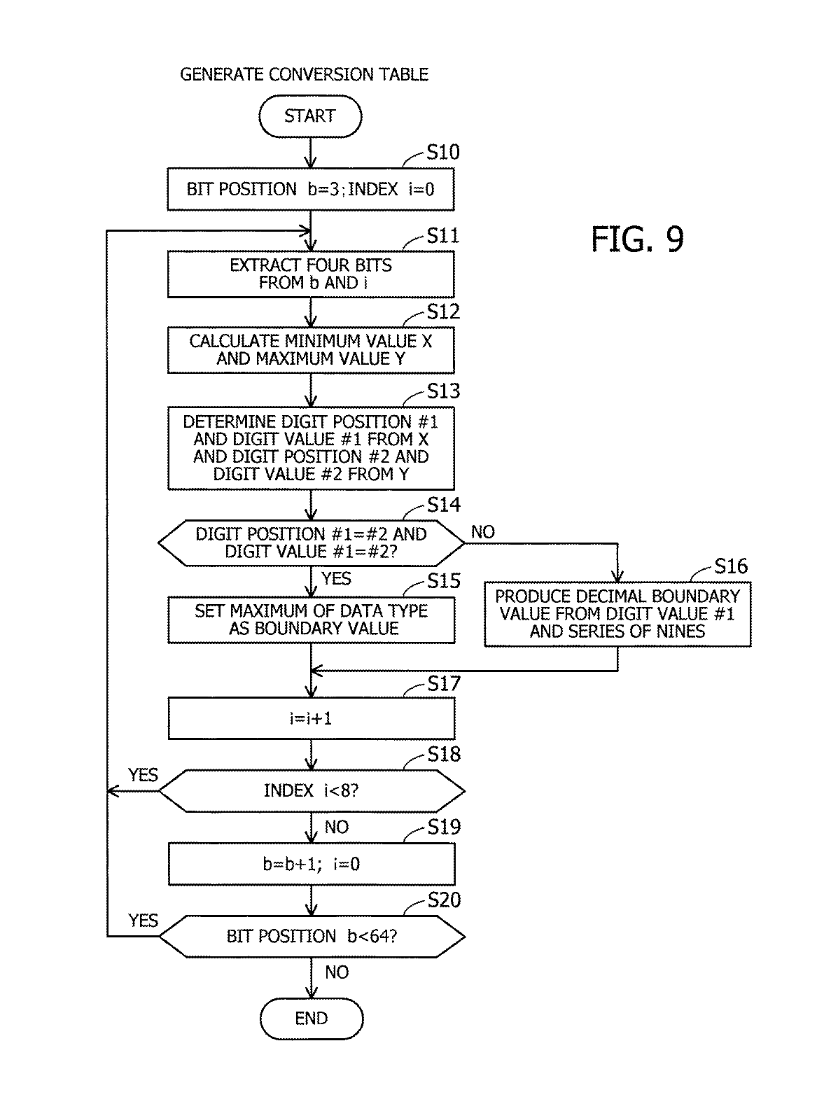

FIG. 9 illustrates an exemplary procedure of generating a conversion table. The proposed information processing apparatus 100 may be configured to produce a conversion table 127 for use by itself. Alternatively, some other apparatus may produce a conversion table 127 and supplies it to the information processing apparatus 100. The procedure described below assumes that the numeric conversion unit 125 in the information processing apparatus 100 generates a conversion table 127.

(S10) The numeric conversion unit 125 initializes bit position b to three and index i to zero, where b and i are integer variables.

(S11) The numeric conversion unit 125 extracts a string of four consecutive bits and its value from the current bit position b and index i. This four-bit string is what have been described as the most significant set bit and three bits subsequent thereto.

(S12) The numeric conversion unit 125 calculates a minimum value X with the assumption that all lower bits below the four-bit string extracted in step S11 are zeros. The numeric conversion unit 125 also calculates a maximum value Y with the assumption that all lower bits below the four-bit string are ones.

(S13) The numeric conversion unit 125 converts the minimum value X of step S12 into decimal form and scans each digit of the resulting decimal number to determine the most significant non-zero digit and its value. The numeric conversion unit 125 assigns the determined digit as digit position #1 and the determined value as digit value #1. The numeric conversion unit 125 also converts the maximum value Y of step S12 into decimal form and scans each digit of the resulting decimal number to determine the most significant non-zero digit and its value. The numeric conversion unit 125 assigns the determined digit as digit position #2 and the determined value as digit value #2. The decimal conversion of minimum value X and maximum value Y may be performed with the foregoing simple algorithm or any other method.

(S14) The numeric conversion unit 125 determines whether the digit positions #1 and #2 of step S13 coincide with each other, as well as whether the digit values #1 and #2 are equal to each other. If both of these tests hold true, then the process advances to step S15. Otherwise, the process goes to step S16.

(S15) The numeric conversion unit 125 assigns the largest value of the applicable data type (e.g., 18,446,744,073,709,551,615 in the case of 64-bit unsigned integers) to the boundary value. The process then advances to step S17.

(S16) The numeric conversion unit 125 produces a decimal number that has the digit value #1 in its digit position #1 and a value of 9 in every lower bit subsequent to the digit position #1. The numeric conversion unit 125 converts the produced decimal number to a binary number and assigns it as the boundary value.

(S17) The numeric conversion unit 125 adds one to index i.

(S18) The numeric conversion unit 125 determines whether index i is smaller than eight. When index i is smaller than eight, the process returns to step S11. When index i is eight, the process advances to step S19.

(S19) The numeric conversion unit 125 adds one to bit position b and initializes index i to zero.

(S20) The numeric conversion unit 125 determines whether bit position b is smaller than 64. When bit position b is smaller than 64, the process returns to step S11. When bit position b is 64, the numeric conversion unit 125 closes the current process of conversion table generation.

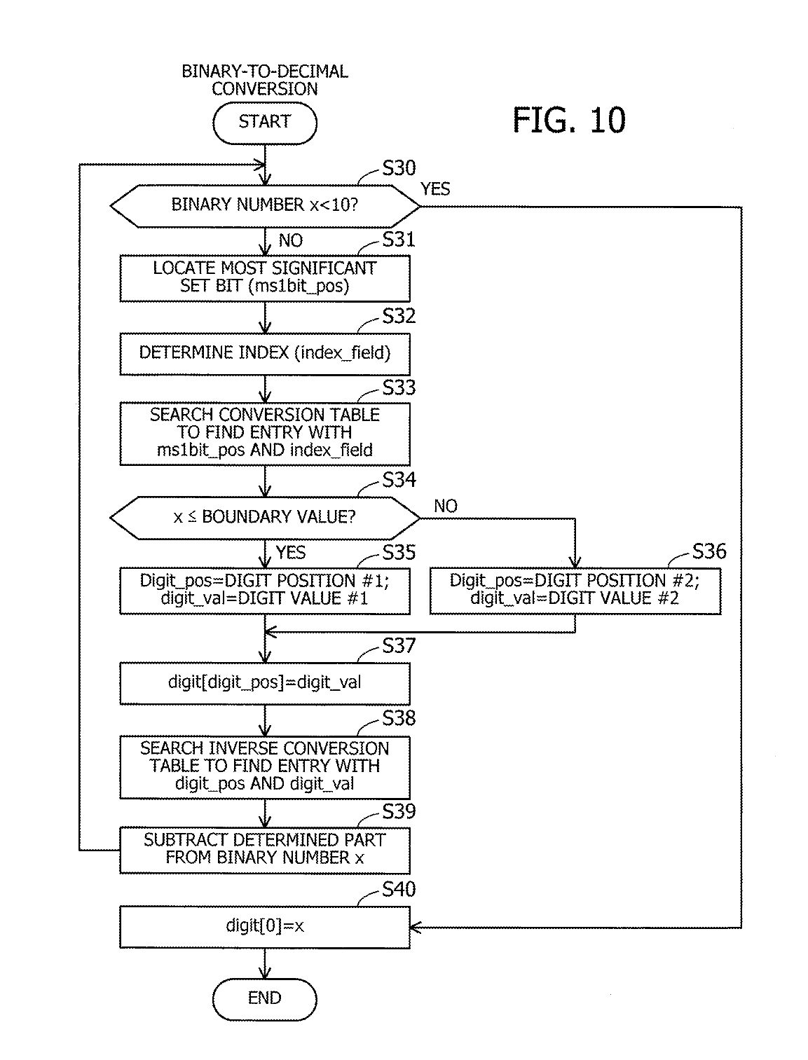

FIG. 10 illustrates an exemplary procedure of binary-to-decimal conversion. It is assumed here that variable x contains a source binary number to be converted.

(S30) The numeric conversion unit 125 determines whether the current value of binary number x is smaller than decimal 10 (or 1010 in binary). If x is smaller than 10, the process goes to step S40. If x is equal to or greater than 10, the process advances to step S31.

(S31) The numeric conversion unit 125 scans the bit string of binary number x to locate its most significant set bit, thus obtaining its position (ms1bit_pos).

The actual method used to find ms1bit_pos may vary depending on the processor architecture of the CPU 101. For example, the CPU 101 may support an instruction for locating the most significant set bit in a binary number. In this case, the numeric conversion unit 125 can use the outcome of that instruction as the most significant set bit position ms1bit_pos. The noted instruction may be called a “Bit Scan Reverse” (BSR) instruction. As another example, the CPU 101 may support an instruction for counting consecutive zeros, if any, from MSB to LSB of a binary number. In that case, the numeric conversion unit 125 can determine ms1bit_pos by subtracting the result of the instruction from 63. The noted instruction may be called a Count Leading Zeros (CLZ) instruction. As yet another example, the CPU 101 may support an instruction that converts an integer to a floating-point number. In that case, the numeric conversion unit 125 may convert the source binary number x to a floating-point number and extracts its exponent component as the most significant set bit position ms1bit_pos.

(S32) Now that step S31 has determined ms1bit_pos, the numeric conversion unit 125 selects the most significant set bit and three bits subsequent thereto. The numeric conversion unit 125 then determines an index (index_field) from the selected three bits.

(S33) The numeric conversion unit 125 searches the conversion table 127 by using ms1bit_pos of step S31 and index_field of step S32 as search keys and extracts a boundary value from a relevant table entry.

(S34) The numeric conversion unit 125 compares the binary number x with the boundary value obtained in step S33, thereby determining whether x is within a specified range. When the binary number x is smaller than or equal to the boundary value, the process advances to step S35. When the binary number x exceeds the boundary value, the process proceeds to step S36.

(S35) With reference to the conversion table 127, the numeric conversion unit 125 obtains digit position #1 and digit value #1 corresponding to the combination of most significant set bit (ms1bit_pos) and index (index_field). The numeric conversion unit 125 then assigns the extracted digit position #1 to a digit position variable (digit_pos), and the extracted digit value #1 to a digit value variable (digit_val). Then the process proceeds to step S37.

(S36) With reference to the conversion table 127, the numeric conversion unit 125 extracts digit position #2 and digit value #2 corresponding to the combination of most significant set bit position (ms1bit_pos) and index (index_field). The numeric conversion unit 125 then assigns the extracted digit position #2 to a digit position variable (digit_pos), and the extracted digit value #2 to a digit value variable (digit_val).

(S37) The numeric conversion unit 125 assigns the value of digit_val to a decimal digit at the position digit_pos. This operation is expressed as digit[digit_pos]=digit_val, where digit_pos and digit_val are values obtained in step S35 or S36.

(S38) The numeric conversion unit 125 calculates a value of digit_val-1 by subtracting one from the digit value variable digit_val. The numeric conversion unit 125 then searches the inverse conversion table 128 by using digit_pos and digit_val-1, thus obtaining a binary number.

(S39) The numeric conversion unit 125 subtracts the binary number obtained in step S38 from the current binary number x, where the subtrahend is equivalent to the decimal digit determined in step S37. In other words, this subtraction removes the determined part from the binary number x. The process then goes back to step S30, with the remaining binary number x.

(S40) The numeric conversion unit 125 assigns the current binary number x to digit[0] of the decimal number. All digits of the decimal number have been determined, including those that remain unchanged from their initial values (i.e., zeros).

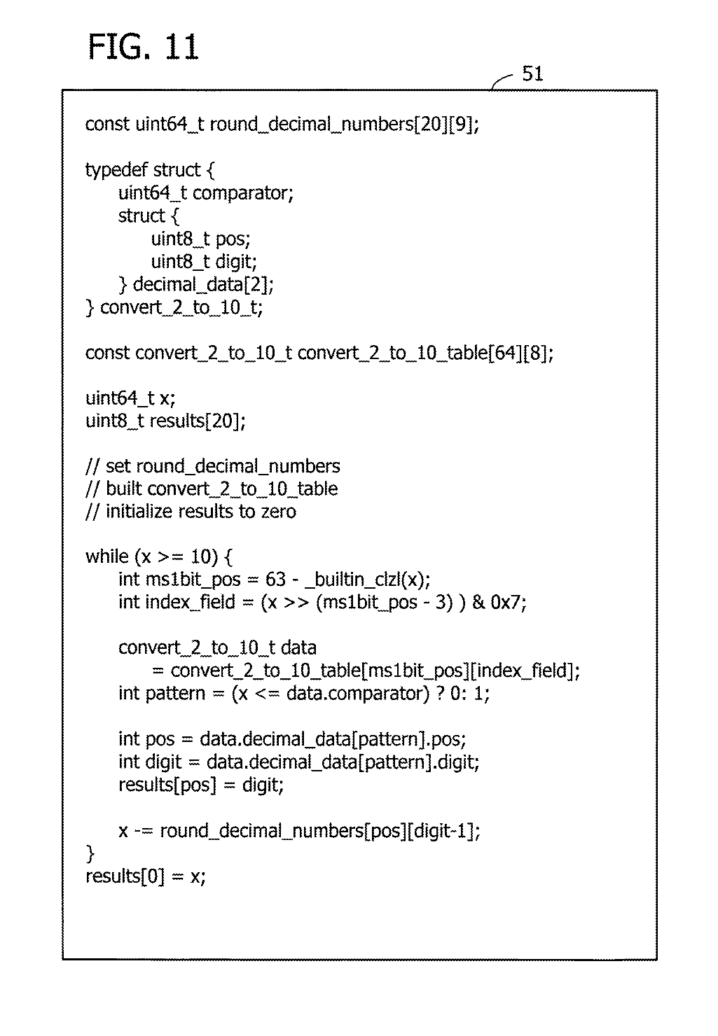

FIG. 11 illustrates an example of a binary-to-decimal conversion program. This program 51 is an implementation of the process flow of FIG. 10.

The program 51 first defines an inverse conversion table 128 as a two-dimensional array, round_decimal_numbers[20][9], with a size of 20×9. Binary numbers in this inverse conversion table 128 are represented in the form of 64-bit unsigned integers. The program 51 also defines a conversion table 127 as another two-dimensional array, convert_2_to_10_table[64][8], with a size of 64×8. The conversion table 127 contains boundary values in the form of 64-bit unsigned integers. The conversion table 127 also contains numbers in digit position #1 and #2 fields and digit_value #1 and #2 fields, each in the form of 8-bit unsigned integers.

A source binary number x is given in the form of a 64-bit unsigned integer. The program 51 also declares a linear array with a size of 20, results[20], for accommodating a decimal number. Each digit of the decimal number is expressed by an 8-bit unsigned integer. Note that the program 51 omits the procedure for loading an inverse conversion table 128 into the two-dimensional array, round_decimal_numbers[20][9], as well as a conversion table 127 into the two-dimensional array, convert 2 to 10 table[64][8]. The program 51 omits the procedure for initializing array elements of results[20] to zero.

The program 51 then calculates the most significant set bit in binary number x by using a built-in function that issues CLZ instructions. The program 51 also extracts an index, index_field, by using shift-right operations and logical AND (&) operations. The program 51 compares the current binary number x with a boundary value, and assigns zero to a variable named “pattern” if the binary number x is smaller than or equal to the boundary value. If binary number x is greater than the boundary value, the program 51 assigns one to pattern. This variable “pattern” is used as the index for selecting either the digit position #1 and digit value #1 fields or the digit position #2 and digit value #2 fields.

As can be seen from the above description, the proposed information processing apparatus 100 of the second embodiment converts a binary number into a decimal number by determining decimal digits one by one, from the most significant digit to the least significant digit. The information processing apparatus 100 has only to perform such conversion processing to determine non-zero digits in the decimal number, while skipping zero-valued digits. The proposed conversion method thus reduces the amount of computation in binary-to-decimal conversion, particularly when converting binary numbers that have many zero-valued digits, such as those describing the amount of money. The conversion table 127 is designed to suggest possible decimal digit positions and values from the bit position and value of each four-bit string found in a binary number. This four-bit string-based method narrows down the candidates for each decimal digit position and value more effectively than other string sizes smaller than four bits, thus simplifying the algorithm. Four-bit strings are also advantageous over five-bit strings or larger strings because they enable downsizing the conversion table 127.

The foregoing data processing operations in the first embodiment may be implemented in the form of a program that the information processing apparatus 10 (FIG. 1) executes. The second embodiment may also implemented as a program for the information processing apparatus 100 (FIGS. 2 and 3). Those programs may be recorded on a non-transitory computer-readable medium (e.g., storage medium 113 in FIG. 2), such as magnetic disks, optical discs, magneto-optical discs, and semiconductor memory devices. Magnetic disk media include FD and HDD. Optical disc media include CD, CD-Recordable (CD-R), CD-Rewritable (CD-RW), DVD, DVD-Recordable (DVD-R), and DVD-Rewritable (DVD-RW). Portable storage media may be used to circulate programs. In that case, the programs may be copied from a portable storage medium to another storage device (e.g., HDD 103) for the purpose of execution.

Several embodiments and their possible variations have been described above. In one aspect of those embodiments and variations, the proposed techniques make it possible to reduce the amount of computation for converting binary number data into decimal number data.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store therein conversion data that indicates correspondence between each four-bit string in binary expression and a single digit in decimal expression; and
a processor configured to perform a procedure including:
selecting four consecutive bits out of binary number data,
determining, with reference to the conversion data in the memory, a value of one digit of decimal number data from a position of the selected four bits in the binary number data and a value of at least part of the selected four bits,
subtracting a binary number corresponding to the determined value of the one digit from the binary number data to calculate a difference therebetween, and
selecting, out of the difference produced by the subtracting, another four consecutive bits located below the previously selected four bits and repeating the determining to determine another digit of the decimal number data so as to convert the binary number data into decimal form.

2. The information processing apparatus according to claim 1, wherein:
the conversion data includes a boundary value and first and second digit positions in decimal expression; and
the determining of a value of one digit includes selecting either the first digit position and the second digit position according to a comparison between the binary number data and the boundary value, and determining a value at the selected digit position in the decimal number data.

3. The information processing apparatus according to claim 1, wherein:
the conversion data includes a boundary value and first and second digit values in decimal expression; and
the determining of a value of one digit includes selecting either the first digit value or the second digit value according to a comparison between the binary number data and the boundary value, and determining the selected digit value as the value of the one digit.

4. The information processing apparatus according to claim 1, wherein the selecting of four consecutive bits includes detecting a foremost bit having a predetermined value in the binary number data, and selecting the detected foremost bit and three consecutive bits subsequent thereto.

5. A binary-to-decimal conversion method comprising:
selecting, by a processor, four consecutive bits out of binary number data;
determining, by the processor, a value of one digit of decimal number data from a position of the selected four bits in the binary number data and a value of at least part of the selected four bits, with reference to conversion data that indicates correspondence between each four-bit string in binary expression and a single digit in decimal expression;
subtracting, by the processor, a binary number corresponding to the determined value of the one digit from the binary number data to calculate a difference therebetween; and
selecting, by the processor, out of the difference produced by the subtracting, another four consecutive bits located below the previously selected four bits and repeating the determining to determine another digit of the decimal number data so as to convert the binary number data into decimal form.

6. A non-transitory computer-readable storage medium storing a program, wherein the program causes a computer to perform a procedure comprising:
selecting four consecutive bits out of binary number data;
determining a value of one digit of decimal number data from a position of the selected four bits in the binary number data and a value of at least part of the selected four bits, with reference to conversion data that indicates correspondence between each four-bit string in binary expression and a single digit in decimal expression;
subtracting a binary number corresponding to the determined value of the one digit from the binary number data to calculate a difference therebetween; and
selecting, out of the difference produced by the subtracting, another four consecutive bits located below the previously selected four bits and repeating the determining to determine another digit of the decimal number data so as to convert the binary number data into decimal form.
